(19) United States
(12) Patent Application Publication
(10) Pub. No.: US 2009/0246305 A1
(43) Pub. Date: Oct. 1, 2009

(54) MOLDING APPARATUS

(75) Inventor: YU-HAN LU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/261,307

(22) Filed: Oct. 30, 2008

(30) Foreign Application Priority Data
Mar. 25, 2008 (CN) 200810300701.1

(51) Int. Cl. B29C 47/92

(52) U.S. Cl. 425/144

(57) ABSTRACT

A molding apparatus includes a mold plate, a mold core received in the mold plate, a plurality of temperature sensors and a heater. A heat passage is defined in the mold plate and adjacent to the mold core. The heat passage is configured for flowing a heating medium therethrough to heat up the mold core. The plurality of temperature sensors are mounted in the mold plate for sensing a temperature of the mold plate. The heater is configured for heating the mold plate according to the temperature sensed by the sensors.

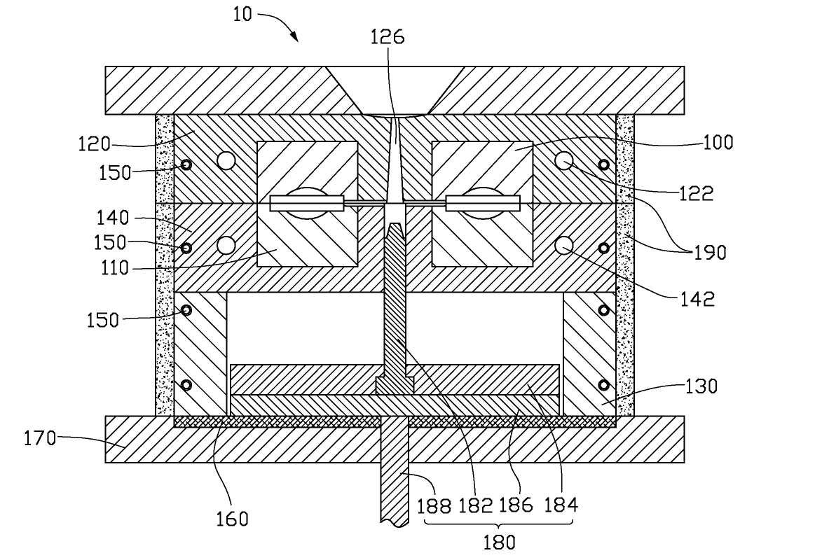

### BACKGROUND

1. Technical Field

The present invention relates generally to molding apparatuses, and particularly, to a molding apparatus which can be easily and precisely positioned.

2. Description of Related Art

With the development of industry, molding processes are widely used for manufacturing workpieces, for example, optical articles such as lenses and light guide plates. Such workpieces need to satisfy oft-conflicting requirements of compactness, low cost, and excellent quality.

The molding apparatus typically includes a first mold part and a second mold part, a first mold core installed in the first mold part and a second mold core installed in the second mold part. A heat passage is defined in each of the first and second mold parts. The heat passages are used for heat medium to pass therethrough to heat the first mold core.

However, the difference of temperatures between the molding apparatus and the environment around the molding apparatus is often large. For example, the temperature of molding apparatus is 140 degrees centigrade and the temperature of the environment around the molding apparatus is 24 degrees centigrade. A temperature of a periphery of the molding apparatus may be reduced due to the low temperature of the environment around the molding apparatus. In such case, the temperature of the heat medium is difficult to be adjusted to compensate the temperature reduction of the periphery of the molding apparatus. Thus, thermal unstability occurs in the molding apparatus.

What is needed, therefore, is a molding apparatus having good thermal stability.

### SUMMARY

A molding apparatus includes a mold plate, a mold core received in the mold plate, a plurality of temperature sensors and a heater. A heat passage is defined in the mold plate and adjacent to the mold core. The heat passage is configured for flowing a heating medium therethrough to heat up the mold core. The plurality of temperature sensors are mounted in the mold plate for sensing a temperature of the mold plate. The heater is configured for heating the mold plate according to the temperature sensed by the sensors.

Other advantages and novel features of the molding apparatus will become more apparent from the following detailed description when taken in conjunction with the accompanying drawings.

### BRIEF DESCRIPTION OF THE DRAWING

Many aspects of the molding apparatus can be better understood with reference to the following drawing. The components in the drawing are not necessarily drawn to scale, the emphasis instead being placed upon clearly illustrating the principles of the present molding apparatus.

The drawing is a cross-sectional view of a molding apparatus of an exemplary embodiment.

### DETAILED DESCRIPTION OF THE EMBODIMENTS

Embodiments of the present molding apparatus will now be described in detail below and with reference to the drawing.

Referring to the drawing, a molding apparatus 10 includes a first mold part 120, two first mold cores 100 installed in the first mold part 120, a second mold part 140, and two second mold cores 110 installed in the second mold part 140. The two first mold cores 100 are positioned opposite to the two second mold cores 110, respectively.

The molding apparatus 10 further includes two support blocks 130, a heater 160 and a base plate 170. The two support blocks 130 contact two opposite edges of one surface of the second mold part 140 opposite to the first mold part 120 and are configured for supporting the first and second mold parts 120, 140. In this embodiment, the support block 130 also has a function of transferring heat to the first and second mold parts 120 and 140. Therefore, the support block 130 may be made of a material having good thermal conductivity, for example iron, copper and aluminum alloy. The heater 160 is disposed between the base plate 170 and the support block 130. The heater 160 is configured for heating the support block 130, the first and second mold parts 120, 140.

The molding apparatus 10 further includes an ejection mechanism 180. The ejection mechanism 180 includes a pulling rod 182 penetrates through the second mold part 140, a retaining plate 184 for retaining the pulling rod 182, a pushing plate 186 disposed between the retaining plate 184 and the heater 160, and an ejection pin 188 penetrating through the base plate 170 and the heater 160, and contacting the pushing plate 186. The ejection pin 188 is configured for pushing the pushing plate 186, and the pulling rod 182 is further pushed to eject the molded product (not shown) or stub bar (not shown) formed by molded materials in a runner 126 defined in the first mold part 120.

A first heat passage 122 is defined in the first mold part 120 and around the first mold core 100. The first heat passage 122 is configured for facilitating a heat medium with a predetermined temperature flowing therethrough to heat the first mold core 100. A second heat passage 142 is defined in the second mold part 140 and around the second mold core 110. The second heat passage 142 is configured for facilitating a heat medium with a predetermined temperature flowing therethrough to heat the second mold core 110.

Two sensors 150 are installed in a periphery portion of each of the first and second mold part 120, 140. The sensors 150 in the first and second mold parts 120, 140 are configured for sensing temperatures of the periphery portions of the first and second mold parts 120, 140, respectively. Four sensors 150 are installed in the support block 130 and configured for sensing a temperature thereof. The sensors 150 installed in the first mold part 120, the second mold part 140 and the support block 130 are all electrically connected with the heater 160 for sending real-time electrical signals of information about the temperatures of the first mold part 120, the second mold part 140, and the support block 130 to the heater 160. The temperature values of the first mold part 120, the second mold part 140, and the support block 130 will compared with a predetermined value stored in a memory (not shown). When the temperature of at least one of the first mold part 120, the second mold part 140, and the support block 130 is lower than the predetermined value, the heater 160 heats up the support block 130 based on the received electrical signals, and the heat is then transferred to the periphery of the first and second mold parts 120, 140. Thus, the first mold part 120, the second mold part 140 and the support block 130 maintain good heat stability.

In this embodiment, the sensor 150 can be a thermoelectric sensor, for example a thermocouple sensor, a thermo-resistance sensor and a thermistor sensor. The heater 160 can be an electric heater electrically connected with a direct current power supply. A temperature of the heater 160 can be changed by controlling the amount of the power supplied.

It is to be understood that the number of the sensors 150 respectively in the first mold part 120, the second mold part 140 and the support block 130 can be changed according to need. In addition, the number of the heater 160 can be changed according to need. The heater 160 can also be positioned contacting the side surfaces of the first and second mold parts 120, 140 to heat up the peripheries of the first and second mold parts 120 and 140.

The molding apparatus 10 can further include a thermal insulation layer 190 covering the side surface of the first mold part 120, the second mold part 140 and the support block 130. The thermal insulation layer 190 is configured for preventing heat in the first mold part 120, the second mold part 140 and the support block 130 from being transmitted into atmosphere, thus maintaining the heat stability of the first mold part 120, the second mold part 140 and the support block 130. The thermal insulation layer 190 can be made of asbestos or fiberglass.

It is understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A molding apparatus, comprising:
a mold plate;
a mold core received in the mold plate;
a heat passage defined in the mold plate, adjacent to the mold core, the heat passage configured for flowing a heating medium therethrough to heat up the mold core;
a plurality of temperature sensors mounted in the mold plate for sensing a temperature of the mold plate; and
a heater configured for heating the mold plate according to the temperature sensed by the sensors.

2. A molding apparatus comprising:
a first mold part including a first passage for flowing a heating medium therethrough;
a second mold part including a second passage for flowing a heating medium therethrough;
a first mold core received in the first mold part;
a second mold core received in the second mold part, the first and second molding cores cooperatively defining a molding cavity therebetween; a plurality of temperature sensors mounted in the first mold part and the second mold part for sensing temperatures of the first mold part and the second mold part; and
a heater for heating the first mold part and the second mold part.

3. The molding apparatus of claim 2, wherein the temperature sensors are installed in a peripheral portion of the first mold part and a peripheral portion of the second mold part.

4. The molding apparatus of claim 3, further comprising a base plate, a thermally conductive support block interposed between the base plate and the second mold part, and two second temperature sensors installed in the support block, the second temperature sensors being configured for sensing a temperature of the support block, thus sensing the temperature of the second mold part.

5. The molding apparatus of claim 4, further comprising an ejecting pin mounted to the base plate, wherein the heater is mounted on the base plate and thermally contacting the support block, the support block being configured for supporting the first and second mold parts and transferring heat to the first and second mold parts from the heater.

6. The molding apparatus of claim 2, wherein the heater is an electric heater.

7. The molding apparatus of claim 2, wherein the temperature sensors include thermoelectric sensors.

8. The molding apparatus of claim 7, wherein the thermoelectric sensor is selected from the group consisting of a thermocouple sensor, a thermo-resistance sensor and a thermistor sensor.

9. The molding apparatus of claim 3, further comprising a thermal insulation layer covering a peripheral side surface of the first mold part and the second mold part for preventing heat dissipation therefrom.

10. The molding apparatus of claim 9, wherein the thermal insulation layer is comprised of a material selected from the group consisting of asbestos and fiberglass.
